(19) United States
(12) Patent Application Publication
(10) Pub. No.: US 2025/0260895 A1
(43) Pub. Date: Aug. 14, 2025

(54) OVEN COMPRISING CAMERA AND METHOD FOR CONTROLLING SAME

(71) Applicant: SAMSUNG ELECTRONICS CO., LTD., Suwon-si (KR)

(72) Inventors: Seulkee LEE, Suwon-si (KR); Hwan CHANG, Suwon-si (KR); Jongho LEE, Suwon-si (KR)

(73) Assignee: SAMSUNG ELECTRONICS CO., LTD., Suwon-si (KR)

(21) Appl. No.: 19/191,280

(22) Filed: Apr. 28, 2025

Related U.S. Application Data
(63) Continuation of application No. PCT/KR2023/015680, filed on Oct. 12, 2023.

(30) Foreign Application Priority Data
Nov. 14, 2022 (KR) 10-2022-0151744

(51) Int. Cl. H04N 23/60; A47J 36/32; F24C 15/04; G06T 7/62; G06T 7/70; G06V 20/68

(52) U.S. Cl. CPC H04N 23/64; A47J 36/321; F24C 15/04; G06T 7/62; G06T 7/70; G06V 20/68; G06T 2207/30242

(57) ABSTRACT

An oven and a method for controlling same where the oven comprises: a door; a camera; a communication interface; and one or more processors. The one or more processors acquire, by of a camera, a first image of at least one food item, displays, on an area of the door on the basis of the acquired first image, a guide UI for the at least one food item, transmits the first image to a server device through the communication interface, receives volume information on the at least one food item from the server device, and determines a cooking process for the at least one food item based on the volume information. At this time, the volume information on the at least one food item is obtained on the basis of the first image and a second image acquired by a user terminal device according to the UI.

### CROSS-REFERENCE TO RELATED APPLICATION

This application is a continuation application is a continuation application, under 35 U.S.C. § 111(a), of international application No. PCT/KR2023/015680, filed Oct. 12, 2023, which claims priority under 35 U. S. C. § 119 to Korean Patent Application No. 10-2022-0151744, filed Nov. 14, 2022, the disclosures of which are incorporated herein by reference in their entireties.

### TECHNICAL FIELD

The disclosure relates to an oven including a camera and a method for controlling the same. More particularly, the disclosure relates to an oven which obtains an image of a cooking material in the oven using a camera, and obtains information about the cooking material based on the obtained image, and a method for controlling the same.

### BACKGROUND ART

An oven may be a device that heats and cooks cooking materials contained in the oven. If ovens of the related art involved users performing a simple cooking process of heating cooking materials according to a set time or temperature, ovens have become able to perform more variety of functions with recent developments in electronic technology. For example, an oven may allow a user to more accurately and intuitively observe a cooking process of cooking materials by capturing the cooking process of the cooking material from an inside of the oven using a camera provided in the oven. In addition, the oven may recommend to the user a cooking mode or a cooking processor suitable to the cooking material according to the cooking material.

### TECHNICAL SOLUTION

According to an embodiment of the disclosure, an oven includes a door, a camera, a communication interface, and one or more processors. The door is to be connected to one side of the oven such that while the door is connected to the one side of the oven, the door opens and closes the oven, and includes a display panel at an area that is transparent. The one or more processors are configured to obtain a first image set of at least one cooking material that is to be cooked in the oven using the camera, display a guide user interface (UI) for guiding capturing of the at least one cooking material at an area of the door based on the obtained first image set, transmit the first image set to a server device through the communication interface, receive volume information of the at least one cooking material from the server device, and determine a cooking process for the at least one cooking material based on the volume information. At this time, the volume information of the at least one cooking material is obtained based on the first image set and a second image set obtained by a user terminal device according to the guide UI.

According to an embodiment of the disclosure, a method for controlling an oven includes obtaining a first image set of at least one cooking material that is to be cooked in the oven using a camera. In addition, the method includes displaying a guide user interface (UI) for guiding capturing of the at least one cooking material at a transparent first area of a door of the oven based on the obtained first image set. In addition, the method includes transmitting the first image set to a server device through a communication interface. In addition, the method includes receiving volume information of the at least one cooking material from the server device. In addition, the method includes determining a cooking process for the at least one cooking material based on the volume information. Here, the door is connected to one side of the oven to open and close the oven and includes a display panel at the first area. In addition, the volume information of the at least one cooking material is obtained based on the first image set and a second image set obtained by a user terminal device according to the guide UI.

Meanwhile, according to an embodiment of the disclosure, a control method of an oven is executed by a processor of the oven according to computer instructions stored in a non-transitory computer-readable storage medium. At this time, the control method of the oven includes obtaining a first image set of at least one cooking material in the oven using a camera. In addition, the method includes displaying a guide user interface (UI) for guiding capturing of the at least one cooking material at a transparent first area of a door of the oven based on the obtained first image set. In addition, the method includes transmitting the first image set to a server device through a communication interface. In addition, the method includes receiving volume information of the at least one cooking material from the server device. In addition, the method includes determining a cooking process for the at least one cooking material based on the volume information. Here, the door is connected to one side of the oven to open and close the oven and includes a display panel at the first area. In addition, the volume information of the at least one cooking material is obtained based on the first image set and a second image set obtained by a user terminal device according to the guide UI.

### DESCRIPTION OF DRAWINGS

FIG. 1 is a perspective view of an oven according to an embodiment of the disclosure;

FIG. 2 is a front view of an oven according to an embodiment of the disclosure;

FIG. 3 is a block diagram schematically illustrating an oven according to an embodiment of the disclosure;

FIG. 4 is a flowchart schematically illustrating a control method of an oven according to an embodiment of the disclosure;

FIG. 5 is an example diagram illustrating a capture guide UI displayed at a door of an oven according to an embodiment of the disclosure;

FIG. 6 is an example diagram illustrating a user terminal device obtaining a front image of a cooking material based on a capture guide UI displayed at a door of an oven according to an embodiment of the disclosure;

FIG. 7 is a flowchart illustrating a method for determining a position of a capture guide UI based on an image of a cooking material obtained through a camera according to an embodiment of the disclosure;

FIG. 8 is an example diagram illustrating a method for determining a position of a capture guide UI based on an image of a cooking material obtained through a camera according to an embodiment of the disclosure;

FIG. 9 is an example diagram illustrating a method for determining a size of a capture guide UI based on an image of a cooking material obtained through a camera according to an embodiment of the disclosure;

FIG. 10 is a flowchart illustrating a method for determining a number of capture guide UIs based on an image of a cooking material obtained through a camera according to an embodiment of the disclosure;

FIG. 11 is an example diagram illustrating a method for determining a number of capture guide UIs based on an image of a cooking material obtained through a camera according to an embodiment of the disclosure;

FIG. 12 is an example diagram illustrating a method for identifying whether a first cooking material, of which a portion of the cooking material is obscured by another cooking material, is present based on an image of the cooking material obtained through a camera according to an embodiment of the disclosure; and

FIG. 13 is an example diagram illustrating a method for displaying a recapture request message on an oven based on receiving a recapture request signal of a server according to an embodiment of the disclosure.

### MODE FOR INVENTION

Various modifications may be made to the embodiments of the disclosure, and there may be various types of embodiments. Accordingly, specific embodiments will be illustrated in drawings, and described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. With respect to the description of the drawings, like reference numerals may be used for like elements.

In describing the disclosure, in case it is determined that the detailed description of related known technologies may unnecessarily confuse the gist of the disclosure, the detailed description thereof will be omitted.

Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

Terms used in the disclosure have been merely used to describe a specific embodiment, and is not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

Conversely, when a certain element (e.g., first element) is indicated as “directly coupled with/to” or “directly connected to” another element (e.g., second element), it may be understood as the other element (e.g., third element) not being present between the certain element and the another element.

The expression “configured to . . . (or set up to)” used in the disclosure may be used interchangeably with, for example, “suitable for . . . ,” “having the capacity to . . . ,” “designed to . . . ,” “adapted to . . . ,” “made to . . . ,” or “capable of . . . ” based on circumstance.

The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, a phrase “a processor configured to (or set up to) perform A, B, or C” may mean a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term ‘module’ or ‘part’ used in the embodiments perform at least one function or operation, and may be implemented with a hardware or software, or implemented with a combination of hardware and software. In addition, a plurality of ‘modules’ or a plurality of ‘parts’, except for a ‘module’ or a ‘part’ which needs to be implemented with a specific hardware, may be integrated in at least one module and implemented as at least one processor.

The various elements and areas of the drawings have been schematically illustrated. Accordingly, the technical spirit of the disclosure is not limited by relative sizes and distances illustrated in the accompanied drawings.

Embodiments of the disclosure will be described in detail below with reference to the accompanying drawings to aid in the understanding of those of ordinary skill in the art.

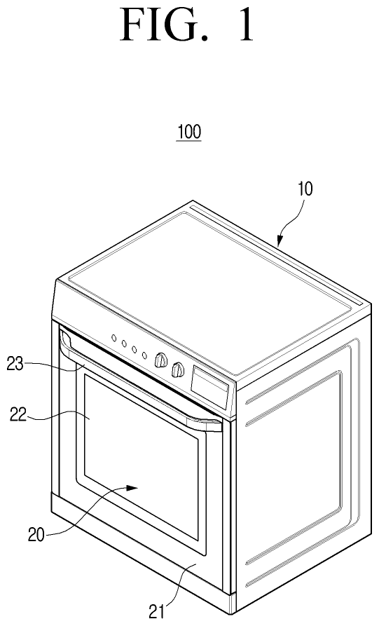

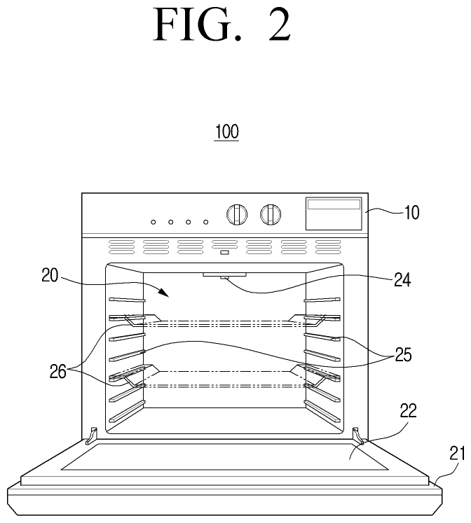

FIG. 1 is a perspective view of an oven according to an embodiment of the disclosure. FIG. 2 is a front view of an oven according to an embodiment of the disclosure

An oven 100 shown in FIG. 1 and FIG. 2 is merely one example. According to various embodiments of the disclosure, the oven 100 may be implemented into various forms.

Referring to FIG. 1, the oven 100 may include a main body 10 that forms the exterior. In addition, the oven 100 may include a receiving space that is opened toward one side thereof. The receiving space may be a cooking chamber 20 in which cooking materials that are disposed in the receiving space are cooked. The cooking chamber 20 may be opened toward a front direction of the oven 100. The cooking materials may be objects that are cooked through the oven 100, and include various food products such as chickens, pizzas, pies, and the like.

The cooking chamber 20 may be formed in a box shape. At this time, the cooking chamber 20 may be opened toward the front direction of the oven 100 to take out the cooking material. Specifically, the front surface of the cooking chamber 20 may be opened and closed by a door 21 connected to the main body 10. To this end, the door 21 may be rotatably connected to one side surface of the main body 10. In an example, the door 21 may be connected to a lower part of the main body 10 through a hinge. However, the above is not limited thereto, and the door 21 may be provided at a right side or a left side of the main body 10.

At a front surface of the door 21, a handle 23 may be provided making opening and closing of the door 21 easy. A user may grab the handle 23 and open the door 21 to put in or take out cooking materials in the cooking chamber 20 by grabbing the handle 23 and opening the door 21.

Referring to FIG. 1, the door 21 may include glass through which a cooking process of a cooking material inside the cooking chamber 20 can be checked from the outside, and a see-through part 22 provided with a transparent material such as a transparent plastic. In addition, the door 21 may include a frame that forms the exterior of the door 21. At this time, the frame may include a frame opening to form the see-through part 22. At this time, based on at least one transparent member (e.g., glass, transparent plastic, etc.) being disposed at the frame opening, the see-through part 22 of the door 21 may be implemented.

Meanwhile, according to an embodiment of the disclosure, the oven 100 may include a camera 24. The camera 24 may obtain an image of a cooking material by capturing the cooking material in the oven 100. Referring to FIG. 2, the camera 24 may be disposed at an upper surface inside of the cooking chamber 20. At this time, the camera 24 may obtain, based on receiving the cooking material in the cooking chamber 20, an image of a top surface of the cooking material by capturing the cooking material.

Meanwhile, referring to FIG. 2, a plurality of supports 25 may be provided inside of the cooking chamber 20. The plurality of supports 25 may be provided to protrude from a left side wall and a right sidewall inside the cooking chamber 20. A rack 26 on which the cooking materials may be placed may be mounted to the plurality of supports 25. In addition, a divider capable of vertically dividing the space of the cooking chamber 20 may be separably mounted to the plurality of supports 25. Specifically, the divider may vertically divide the space of the cooking chamber 20 by being horizontally mounted to the cooking chamber 20.

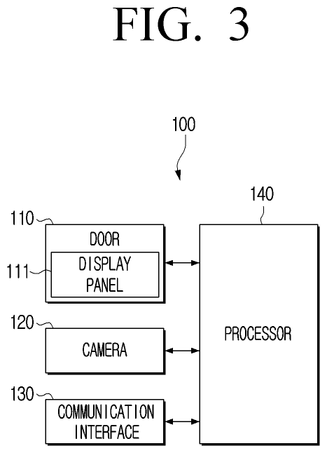

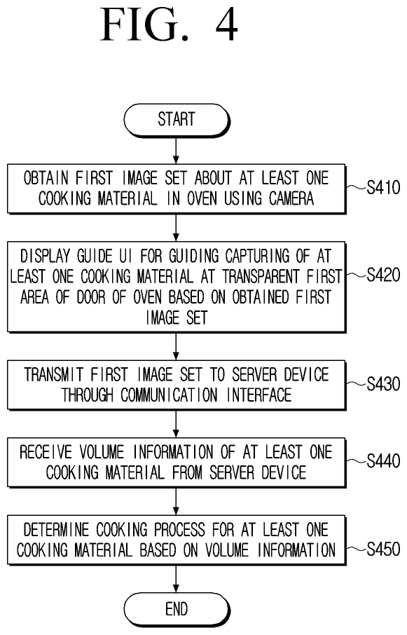

FIG. 3 is a block diagram schematically illustrating an oven according to an embodiment of the disclosure. FIG. 4 is a flowchart schematically illustrating a control method of an oven according to an embodiment of the disclosure.

According to an embodiment of the disclosure, the oven 100 may include a door 110, a camera 120, and one or more processors 140.

The door 110 may be connected to one side of the oven 100 to open and close the oven 100 and include a display panel 111 at a transparent first area. Meanwhile, the door 110 and the camera 120 in FIG. 3 may correspond to the door 110 and the camera 120 described in FIG. 1 and FIG. 2.

The door 110 may include the display panel 111 at one area of the see-through part 22. In an example, if the door 110 includes a plurality of glasses (e.g., a front surface glass and a rear surface glass), the display panel 111 may be provided between the plurality of glasses and stacked. The door 100 may display an image, a picture, and the like at one area of the see-through part 22 of the door 110 through the display panel 111.

The display panel 111 may be implemented as a liquid crystal display (LCD) panel, a light emitting diode (LED) panel, an organic light emitting diode (OLED) panel, a micro light emitting diode (uLED) panel, a plasma display panel 111 (PDP), and the like. However, the display panel 111 is not limited thereto, and may be implemented in various forms that can visually display an optical image corresponding to image data.

The camera 120 may obtain an image by capturing the inside of the cooking chamber 20 of the oven 100. Specifically, the camera 120 may obtain an image of the cooking material 2 by capturing the cooking material 2 when the cooking material 2 is placed inside the cooking chamber 20 of the oven 100. Here, the image may include a still image and/or a moving image including a plurality of images. The image may be replaced by the expression an image set. For example, the image set may include an image or a plurality of images. The plurality of images may include images captured by a time interval. The time interval may include a fixed time interval or a variable time interval. Meanwhile, the camera 120 may obtain a top image of the cooking material 2 according to the camera 120 being mounted at the upper surface inside of the cooking chamber 20.

The camera 120 may be implemented with capturing devices such as a capturing device having a CMOS structure (CMOS Image sensor (CIS)), a capturing device having a charge coupled device (CCD) structure, and the like. However, the embodiment is not limited thereto, and the camera 120 may be implemented with camera 120 modules of various resolutions capable of capturing a subject.

Meanwhile, the camera 120 may be implemented as a depth camera 120 (e.g., an IR depth camera 120, etc.), a stereo camera 120, an RGB camera 120, or the like. Accordingly, in an image of the cooking material 2 obtained through the camera 120, depth information about the cooking material 2 may be included. Here, the depth information may be distance information from the camera 120 to the cooking material 2.

The communication interface 130 may receive input of data and information of various types by performing communication with an external device. For example, the communication interface 130 may receive data, information, and the like of various types from home appliances (e.g., a display device, an air conditioner, an air purifier, etc.), an external storage medium (e.g., a USB memory), an external server (e.g., WEBHARD), or the like through a communication method such as, for example, and without limitation, an AP based Wi-Fi (e.g., Wi-Fi, wireless LAN network), Bluetooth, ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like.

Specifically, the communication interface 130 according to an embodiment of the disclosure may perform communication with a server device that cooperates with the oven 100. Specifically, the communication interface 130 may transmit an image of the cooking material 2 obtained through the camera 120 to the server device. In addition, the communication interface 130 may receive information about the cooking material 2 obtained based on the image from the server device. Here, the information about the cooking material 2 may include information such as a volume, a type, and a mass of the cooking material 2.

The one or more processors 140 according to an embodiment of the disclosure may control the overall operation and function of the oven 100.

The one or more processors 140 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 140 may control one or a random combination from among other elements of an electronic device, and perform an operation associated with communication or data processing. The one or more processors 140 may execute one or more programs or instructions stored in the memory. For example, the one or more processors 140 may perform, by executing one or more instructions stored in the memory, a method according to an embodiment of the disclosure.

When a method according to an embodiment of the disclosure includes a plurality of operations, the plurality of operations may be performed by one processor 140, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The one or more processors 140 may be implemented as a single core processor that includes one core, or as one or more multicore processors that include a plurality of cores (e.g., a homogeneous multicore or a heterogeneous multicore). If the one or more processors 140 are implemented as a multicore processor, each of the plurality of cores included in the multicore processor may include a memory inside the processor such as a cache memory and an on-chip memory, and a common cache shared by the plurality of cores may be included in the multicore processor. In addition, each of the plurality of cores (or a portion from among the plurality of cores) included in the multicore processor may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processor. For example, when a first operation, a second operation, and a third operation are performed by a method according to an embodiment, the first operation, the second operation, and the third operation may all be performed by a first core included in the multicore processor, or the first operation and the second operation may be performed by the first core included in the multicore processor and the third operation may be performed by a second core included in the multicore processor.

In the embodiments of the disclosure, the processor may refer to a system on chip (SoC), a single core processor 140, or a multicore processor in which the one or more processors and other electronic components are integrated or a core included in the single core processor or the multicore processor, and the core herein may be implemented as the CPU, the GPU, the APU, the MIC, the DSP, the NPU, the hardware accelerator, the machine learning accelerator, or the like, but the embodiments of the disclosure are not limited thereto.

For convenience of description, the one or more processors 140 will be referred to as the processor 140 below.

Referring to FIG. 4, the processor 140 may obtain a first image 30 about at least one cooking material 2 in the oven 100 using the camera 120 (S410). The term “first image 30” may be replaced with the representation of a first image set.

The processor 140 may capture, based on detecting the at least one cooking material 2 being disposed in the cooking chamber 20 of the oven 100 or receiving a user input controlling the camera 120 to obtain an image, the at least one cooking material 2 in the cooking chamber 20 of the oven 100 using the camera 120, and obtain an image of the cooking material 2.

Specifically, the processor 140 may use the camera 120 and detect the at least one cooking material 2 being disposed in the oven 100. In an example, if the door 110 of the oven 100 is opened, the processor 140 may repeatedly obtain an image inside the cooking chamber 20 of the oven 100 using the camera 120. At this time, the processor 140 may identify, based on an object (i.e., the at least one cooking material 2) being detected from the obtained image, the at least one cooking material 2 as having been disposed in the cooking chamber 20 of the oven 100. Further, the processor 140 may obtain an image of the at least one cooking material 2 using the camera 120.

In addition, the processor 140 may receive an instruction for controlling the camera 120 through the communication interface 130 or a user interface provided in the oven 100. At this time, the instruction for controlling the camera 120 may be an instruction for operating the camera 120 and capturing the inside of the cooking chamber 20. Further, the processor 140 may obtain an image by capturing the inside of the cooking chamber 20 of the oven 100 according to the received instruction.

For convenience of description below, the image obtained through the camera 120 of the oven 100 may be referred to as the first image 30. The first image 30 may be a top image of the cooking material 2 as described above.

Referring back to FIG. 4, the processor 140 may display a capture guide user interface (UI) 50 (or a guide UI) for guiding capturing of the at least one cooking material 2 at a first area of the door 110 based on the obtained first image 30 (S420). Here, the capture guide UI 50 may be a UI that assists in the capturing of the cooking material 2 disposed in the cooking chamber 20 of the oven 100.

Specifically, the processor 140 may identify, based on the first image 30 obtained through the camera 120, a size, a position, a number, and the like of the cooking material 2. Then, the processor 140 may generate the capture guide UI 50 to display at the door 110 based on the identified size, position, number, and the like of the cooking material 2.

In an example, the processor 140 may determine a size of the capture guide UI 50 based on the size of the cooking material 2. Then, the processor 140 may determine a number of capture guide UIs 50 based on the number of cooking materials 2. Then, the processor 140 may determine a position of the capture guide UI 50 on the door 110 based on the position of the cooking material 2.

Then, the processor 140 may display the capture guide UI 50 generated based on the first image 30 through the display panel 111 included in the door 110 at the first area of the door 110. Specifically, the processor 140 may display, based on the cooking chamber 20 of the oven 100 being identified as closed according to the door 110 being closed, the capture guide UI 50 at the first area of the door 110.

Here, the first area of the door 110 may be an area that includes the area at which the display panel 111 included with the see-through part 22 of the door 110 described in FIG. 1 and FIG. 2 is positioned. Accordingly, the processor 140 may display the capture guide UI 50 on the door 110 through the display panel 111.

The capture guide UI 50 may be a UI that assists in capturing the front surface of the cooking material 2 in the oven. Specifically, the processor 140 may display, based on the door 110 being identified as closed, the capture guide UI 50 at the first area of the door 110. Accordingly, the capture guide UI 50 may be a UI that assists to capture the front image of the cooking material 2 in the oven 100 in light of being displayed at a front surface part of the door 110.

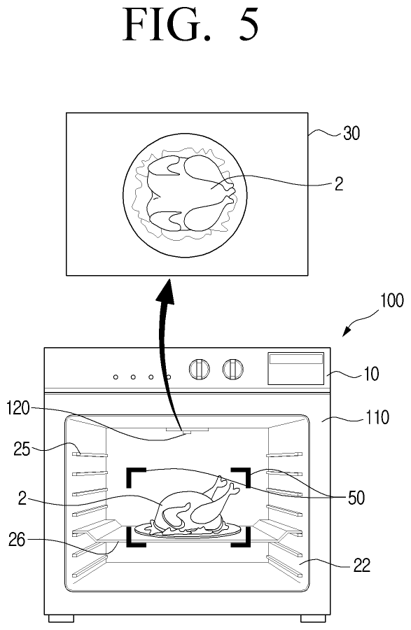

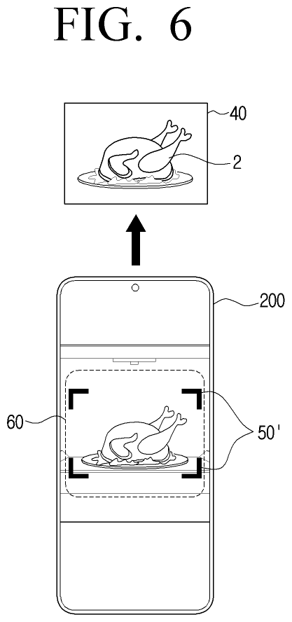

FIG. 5 is an example diagram illustrating the capture guide UI 50 displayed at the door 110 of the oven 100 according to an embodiment of the disclosure. FIG. 6 is an example diagram illustrating a user terminal device 200 obtaining a front image of the cooking material 40 based on the capture guide UI 50′ displayed at the door 110 of the oven 100 according to an embodiment of the disclosure

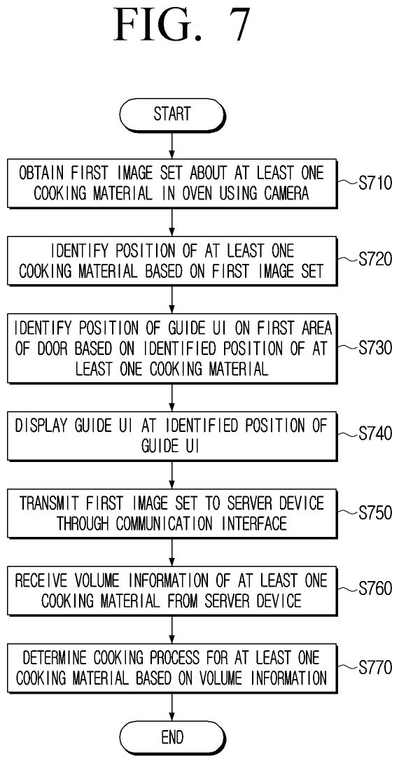

Referring to FIG. 5, the capture guide UI 50 may be displayed on the see-through part 22 of the door 110 of the oven 100. The processor 140 may guide the user to obtain an appropriate image of the cooking material 2 through the see-through part 22 of the door 110 from the outside of the oven 100 using the user terminal device 200 according to the capture guide UI 50. At this time, the processor 140 may also guide the position of the cooking material 2 in the oven 100 using the capture guide UI 50. The embodiment of the disclosure associated therewith will be described in detail in FIG. 7.

Meanwhile, the user terminal device 200 according to an embodiment of the disclosure may be implemented as a smartphone, a PC, a tablet PC, a notebook, and the like.

In an example, the capture guide UI 50 displayed on the door 110 may include a plurality of graphic objects. Specifically, the capture guide UI 50 may include four graphic objects 51, 52, 53, and 54 in which two straight lines are connected having a corner form geometrically. At this time, the four graphic objects may be divided into two graphic objects 51 and 52 positioned at an upper end and two graphic objects 53 and 54 positioned at a lower end. Alternatively, the above may be divided into two graphic objects 51 and 53 positioned at the left side and two graphic objects 52 and 54 positioned at the right side.

Referring to FIG. 6, the user terminal device 200 may be displayed with another capture guide UI 60 as applications, programs, or the like that operations in association with the oven 100 are executed. At this time, the UI displayed in the user terminal device 200 may guide the user to capture an appropriate image of the cooking material 2 in the oven 100 by guiding a capture guide UI 50′ displayed on the door 110 of the oven 100 to be placed in the capture guide UI 60 displayed in the user terminal device 200. Meanwhile, depth information about the cooking material 2 may be included in a second image 40. The term “second image 40” may be replaced with the representation of a second image set. Here, the depth information may include distance information between the user terminal device 200 (specifically, the camera 120 included in the user terminal device 200) and the cooking material 2 in the oven 100.

For convenience of description, an image obtained from the user terminal device 200 according to the capture guide UI 50 displayed on the door 110 will be referred to as the second image 40 below.

According to an embodiment of the disclosure, the processor 140 may display the capture guide UI 50 and then, transmit the first image 30 to the server device through the communication interface 130. Then, the processor 140 may receive volume information of the at least one cooking material 2 from the server device. Here, the volume information of the at least one cooking material 2 may be obtained based on the first image 30 and the second image 40 obtained by the user terminal device 200 according to the UI.

Specifically, the server device may identify a volume of the cooking material 2 in the oven 100 based on the first image 30 received from the oven 100 and the second image 40 obtained from the user terminal device 200. In an example, the server device may synthesize the first image 30 of the top surface of the cooking material 2 and the second image 40 of the front surface of the cooking material 2, and generate a 3D image of the cooking material 2.

For example, the server device may obtain 3D coordinate values for the cooking material 2 (e.g., 3D coordinate values for a space occupied by the cooking material 2 or 3D coordinate values corresponding to each of a plurality of points of the cooking material 2) based on the depth information about the cooking material 2 included in the first image 30 for the top surface of the cooking material 2. Then, the server device may obtain another 3D coordinate values for the cooking material (e.g., 3D coordinate values for the space occupied by the cooking material 2 or 3D coordinate values corresponding to each of the plurality of points of the cooking material 2) based on the depth information about the cooking material 2 included in the second image 40 for the front surface of the cooking material 2.

Then, the server device may match coordinate values corresponding to the same point from among the 3D coordinate values obtained based on the first image 30 and the 3D coordinate values obtained based on the second image 40 in a pre-set 3D coordinate space, and accordingly identify a correction value for identifying coordinate values corresponding to the remaining points in the pre-set 3D coordinate space. Then, the server device may apply the correction value to each of the 3D coordinate values obtained based on the first image 30 and the 3D coordinate values obtained based on the second image 40, and identify a plurality of 3D coordinate values corresponding to the cooking material 2 in a pre-set 3D space.

Alternatively, the server device may obtain 3D information of the cooking material 2 (e.g., 3D image, etc.) by inputting the first image 30 and the second image 40 in a pre-trained neural network model. Here, the pre-trained neural network model may be a trained neural network model using a top part image and front image of each of the plurality of cooking materials 2 as input data of training data and the 3D images of each of the plurality of cooking materials 2 as output data of the training data. For example, for the neural network model trained to output 3D information of the cooking materials 2, various networks may be used such as, for example, and without limitation a Deep Neural Network (DNN), a Convolutional Neural Network (CNN), a Recurrent Neural Network (RNN), a Restricted Boltzmann Machine (RBM), a Deep Belief Network (DBN), a Deep-Q Networks, and the like.

As described, the processor 140 may obtain a 3D image of the cooking material 2 based on the first image 30 and the second image 40 using various methods. Then, the processor 140 may identify a volume of the generated 3D image of the cooking material 2 as the volume of the cooking material.

The processor 140 may determine the cooking process for the at least one cooking material 2 based on volume information. Specifically, the processor 140 may identify, based on the volume information of the cooking material 2 obtained from the server device through the communication interface 130, the volume of the cooking material 2, and determine the cooking process corresponding to the identified volume of the cooking material 2.

In an example, the processor 140 may determine a cooking time or cooking temperature for the cooking material 2 according to a type of the cooking material 2 selected by the user through an input interface and the identified volume of the cooking material 2. For example, even if it is the same cooking material 2, a relatively long cooking time may be determined as the volume of the cooking material 2 is greater, and a relatively short cooking time may be determined as the volume of the cooking material 2 is smaller. In addition, even if it is the same cooking material 2, a relatively long cooking time or a high cooking temperature may be determined as the volume of the cooking material 2 is greater, and a relatively short cooking time or low cooking temperature may be determined as the volume of the cooking material 2 is smaller.

Meanwhile, the processor 140 according to an embodiment of the disclosure may identify a type of the at least one cooking material 2 based on the first image 30, and determine, based on the identified type of the cooking material 2 and the volume information of the cooking material 2, the cooking process corresponding to the at least one cooking material 2. That is, the processor 140 may detect an object included in the first image 30 based on the first image 30, and identify the detected type of object. Accordingly, the processor 140 may identify the type of the cooking material 2 in the oven 100. Specifically, the processor 140 may use, in order to identify the type of the cooking material 2, a trained neural network model to identify the type of the cooking material 2 stored in a memory.

Specifically, the trained neural network model may be stored in the memory of the oven 100 to identify the type of the cooking material 2. Here, the trained neural network model in order to identify the type of the cooking material 2 may be a trained neural network model that uses a plurality of images about top surfaces of the plurality of cooking materials 2 as input data of the training data and the type information of each of the plurality of cooking materials 2 as output data of the training data. For example, for the neural network model trained to identify types of the cooking materials 2, various networks may be used such as, for example, and without limitation a Deep Neural Network (DNN), a Convolutional Neural Network (CNN), a Recurrent Neural Network (RNN), a Restricted Boltzmann Machine (RBM), a Deep Belief Network (DBN), a Deep-Q Networks, and the like.

Thereby, the processor 140 may identify the type of the cooking material 2 even if a user input (i.e., a user input related to the type of the cooking material 2) is not received through the input interface, and determine the cooking process for the cooking material 2 according to the identified volume of the cooking material 2 based on the identified type of the cooking material 2 and the volume information received from the server device. At this time, the processor 140 may display the determined cooking process on a display or the door 110 of the oven 100. Accordingly, the user may receive a recommendation for an appropriate cooking process (e.g., cooking method, cooking time, etc.) for the cooking material 2 the user intends to cook through the oven 100.

In addition, the processor 140 may identify a mass of the cooking material 2 based on the type of the cooking material 2 and the volume of the cooking material 2. Specifically, the processor 140 may identify the mass held by the cooking material 2 based on the above corresponding to the identified volume according to the type of the cooking material 2 (specifically, the type of the cooking material 2 input through the input interface by the user or identified through the neural network model trained to identify the type of the cooking material 2).

To this end, a table included with unit mass to unit volume information according to the respective types of the cooking materials 2 may be stored in the memory. At this time, the processor 140 may identify, after identifying the unit mass to unit volume information corresponding to the types of cooking materials 2 in the table, a mass of the cooking material 2 by applying the identified volume of the cooking material 2.

Meanwhile, the processor 140 may perform cooking of the cooking material 2 based on the identified cooking process. Specifically, the processor 140 may perform cooking of the cooking material 2 with the identified cooking temperature and cooking time based on the type of the cooking material 2 and the volume of the cooking material 2.

At this time, the processor 140 may periodically obtain, while cooking is being performed, images of the cooking material 2 through the camera 120. At this time, the processor 140 may stop, based on the cooking of the cooking material 2 being identified as completed based on the periodically obtained images, the cooking even if a pre-set cooking time is not passed. Alternatively, the processor 140 may transmit information notifying that cooking has been completed to a user terminal device through the communication interface 130 or display on the door 110.

Meanwhile, according to an embodiment of the disclosure, step S420 and step S430 in FIG. 4 may be executed in different order or in parallel. In an example, the processor 140 may display, based on receiving a signal requesting to display the capture guide UI 50 from the server device after transmitting the first image 30 to the server device through the communication interface 130, the capture guide UI 50 on the door 110. At this time, the signal requesting the display of the capture guide UI 50 received from the server device may be transmitted when the server device receives the first image 30 and the received first image 30 is identified as appropriate. That is, based on the first image 30 being identified as an image appropriately captured for obtaining information about the cooking material 2, the server device may transmit the signal requesting to display the capture guide UI 50 to the oven 100.

An embodiment of the disclosure displaying the capture guide UI 50 based o the first image 30 will be described below with reference to FIG. 7 to FIG. 12.

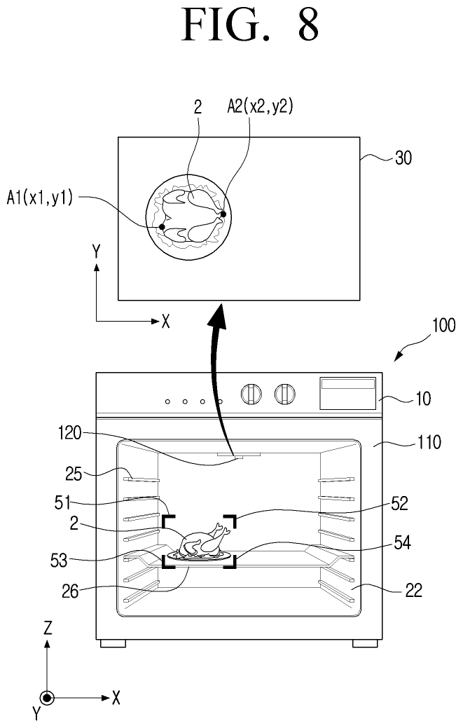

FIG. 7 is a flowchart illustrating a method for determining a position of the capture guide UI 50 based on an image of the cooking material 2 obtained through the camera 120 according to an embodiment of the disclosure, and FIG. 8 is an example diagram illustrating a method for determining a position of the capture guide UI 50 based on an image of the cooking material 2 obtained through the camera 120 according to an embodiment of the disclosure.

Referring to FIG. 7, the processor 140 according to an embodiment of the disclosure may identify, based on the first image 30, a position of the at least one cooking material 2 (S720), identify a position of the capture guide UI 50 on the first area of the door 110 based on the identified position of the cooking material 2 (S730), and display the capture guide UI 50 at the identified position of the capture guide UI 50 (S740). Steps S710, S750, S760, and S770 shown in FIG. 7 may correspond to steps S410, S430, S440, and S470 shown in FIG. 4.

Specifically, the processor 140 may identify the position of the cooking material 2 in the oven 100 based on the first image 30. Then, the processor 140 may identify a position corresponding to the identified position of the cooking material 2 in the oven 100 on the door 110.

In an example, the processor 140 may identify a position of the cooking material on a 2D flat surface based on the first image 30. Referring to FIG. 8, the processor may identify the position of the cooking material 2 in the oven 100 using the first image 30 on an XY plane.

Specifically, the processor 140 may identify an X coordinate value for the cooking material 2. Specifically, the processor 140 may identify an X coordinate value having the smallest value and an X coordinate value having the largest value from among a plurality of X coordinate values for the cooking material 2. At this time, the X coordinate value having the smallest value for the cooking material 2 may be a value corresponding to the most left side point of the cooking material 2, and the X coordinate value having the largest value for the cooking material 2 may be a value corresponding to the most right side point of the cooking material.

Below, the X coordinate value having the smallest value may be referred to as a first coordinate value and the X coordinate value having the largest value may be referred to as a second coordinate value from among the plurality of X coordinate values for the cooking material 2.

The processor 140 may determine the position of the capture guide UI 50 to be displayed on the door 110 based on the first coordinate value and the second coordinate value. Specifically, the processor 140 may identify the position of the cooking material 2 in the oven 100 based on the first coordinate value and the second coordinate value, and display the capture guide UI 50 at an area on the door 110 corresponding to the identified position of the cooking material 2.

Referring to FIG. 8, the processor 140 may identify that the cooking material 2 is positioned at a side surface of one side (left side, when based on a user point of view facing the door 110) rather than the center in the oven 100 based on the first image 30. Accordingly, the processor 140 may control the display panel 111 to identify an area on the door 110 corresponding to the identified position of the cooking material 2 in the oven 100, and to display the capture guide UI 50 at the identified area on the door 110.

Specifically, referring to FIG. 6 and FIG. 8, the processor 140 may determine a position of a graphic object to be displayed at a left side from among the plurality of graphic objects included in the capture guide UI 50 based on the first coordinate value. In addition, the processor 140 may determine a position of a graphic object to be displayed at a right side from among the plurality of graphic objects included in the capture guide UI 50 based on the second coordinate value. Then, the processor 140 may display, based on the determined position, the capture guide UI 50 on the door 110.

Meanwhile, although not clearly shown in the drawings, the processor 140 may obtain height information of the cooking material 2 using the first image 30. Specifically, based on the depth information of the cooking material 2 included in the first image 30, the processor 140 may identify a point closest with the camera 120 on the cooking material 2. This may be a point corresponding to a height of the cooking material 2. Then, the processor 140 may identify a distance between the camera 120 and the point corresponding to the height of the cooking material 2 (hereafter, referred to as a first distance).

In addition, the processor 140 may identify, based on the depth information included in the first image 30, a distance between a plane on which the cooking material 2 is placed and the camera 120. For example, if the cooking material 2 may be disposed on a rack, and the rack is disposed on a plurality of supports in the oven 100, the processor 140 may identify a distance between the camera 120 and the rack based on the depth information included in the first image 30. The distance between the plane on which the cooking material 2 is placed and the camera 120 will be referred to as a second distance below.

Then, the processor 140 may determine a position of the graphic object positioned at an upper part from among the plurality of graphic objects included in the capture guide UI 50 on the door 110 based on first distance information. In addition, the processor 140 may determine a position of the graphic object positioned at a lower part from among the plurality of graphic objects included in the capture guide UI 50 on the door 110 based on second distance information.

At this time, a plurality of graphic objects positioned at an upper end from among the plurality of graphic objects included in the capture guide UI 50 may be displayed at a position corresponding to the height of the cooking material 2 disposed in the oven 100. In addition, a plurality of graphic objects positioned at a lower end from among the plurality of graphic objects may be displayed at a position corresponding to a position of the plane on which the cooking material 2 is placed in the oven 100 (e.g., rack).

As described, the processor 140 may guide, by appropriately adjusting the position of the capture guide UI 50 according to the position of the cooking material 2 positioned in the oven 100, for the user to obtain an appropriate front image of the cooking material 2 using the user terminal device 200. Specifically, the user may accurately identify where the cooking material 2 is positioned in the oven 100 through the capture guide UI 50, and correctly obtain an image of the cooking material 2 (i.e., front image of the cooking material 2) by accurately capturing the cooking material 2.

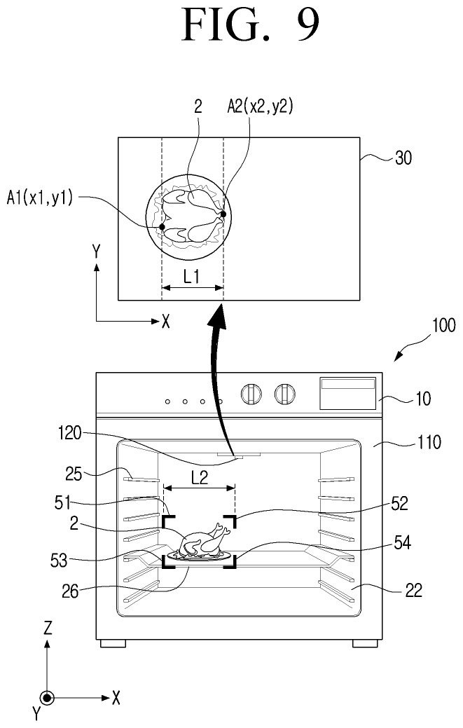

FIG. 9 is an example diagram illustrating a method for determining a size of the capture guide UI 50 based on an image of the cooking material 2 obtained through the camera 120 according to an embodiment of the disclosure.

Meanwhile, the processor 140 according to an embodiment of the disclosure may identify, based on the first image 30, a first length of the at least one cooking material 2, determine a second length of the capture guide UI 50 based on the identified first length, and display the capture guide UI 50 having the determined second length at the first area of the door 110.

The first length may be a maximum width in one side direction of the cooking material 2. In an example, referring to FIG. 9, the first length may be the maximum width of the cooking material 2 identified in an x-axis direction. At this time, the processor 140 may identify the first length of the cooking material 2 based on the above-described first coordinate value and the second coordinate value.

Then, the processor 140 may determine a second length of the capture guide UI 50 based on the identified first length. Here, the second length may be a horizontal length of the capture guide UI 50 (or a distance between a graphic object positioned at the left side and a graphic object positioned at the right side from among the plurality of graphic objects that consist the capture guide UI 50). That is, the processor 140 may identify the maximum width of the cooking material 2 for the cooking material 2 to be safely included in the second image 40 (i.e., image which captured the cooking material 2 from the front surface) obtained by the user terminal device 200 and then, generate the capture guide UI 50 to have a width corresponding to identified maximum width.

Referring to FIG. 9, the processor 140 identified the maximum width of the cooking material 2 as L1 based on the first image 30. At this time, the processor 140 may determine the size of the capture guide UI 50 to be displayed on the door 110 (or a distance between a graphic object positioned at the left side and a graphic object positioned at the right side from among the plurality of graphic objects included in the capture guide UI 50) based on the identified maximum width L1 of the cooking material 2. If the processor 140 determines the width of the capture guide UI 50 as L2 based on the maximum width L1 of the cooking material 2, the processor 140 may generate a capture guide UI 50 having a width of L2, and display the generated capture guide UI 50 on the door 110.

At this time, although not clearly shown in the drawings, the processor 140 may use the depth information included in the first image 30 and determine a height of the capture guide UI 50 (or a distance between a graphic object positioned at the upper part and a graphic object positioned at the lower part from among the plurality of graphic objects included in the capture guide UI 50). In an example, the processor 140 may identify a vertical height of the cooking material 2 based on the first distance and the second distance, and generate a capture guide UI 50 to have a height corresponding to the identified vertical height.

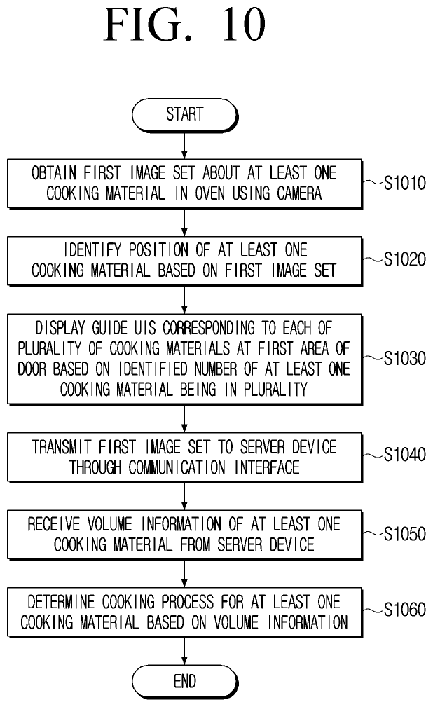

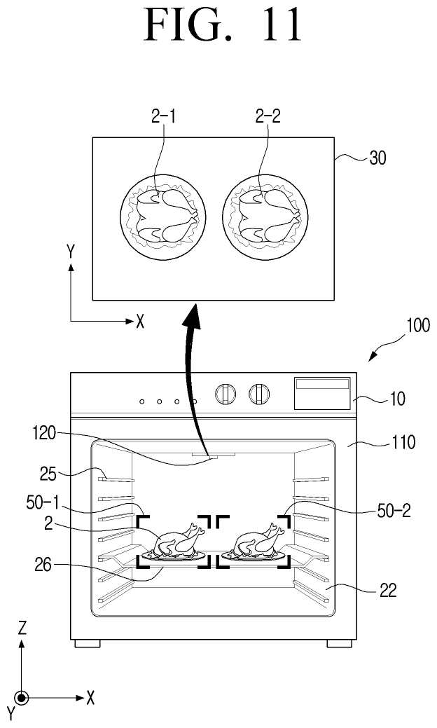

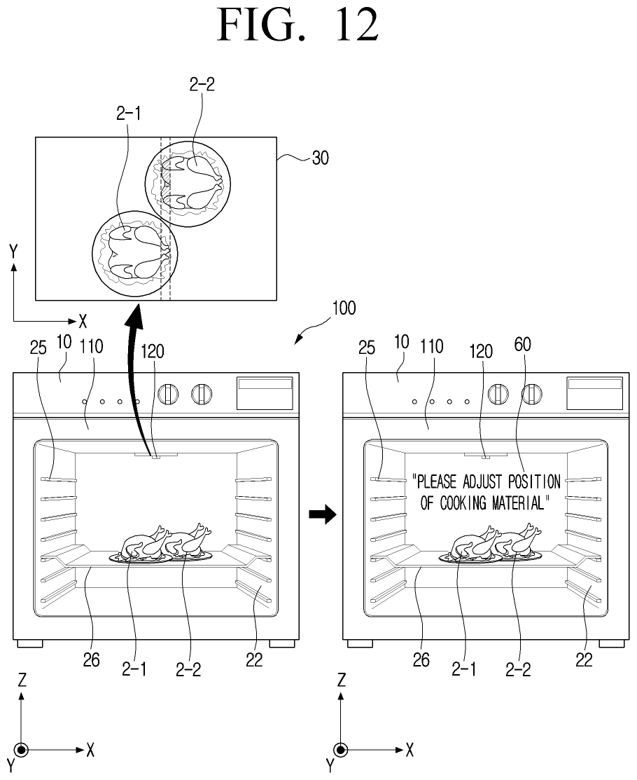

FIG. 10 is a flowchart illustrating a method for determining a number of capture guide UIs 50 based on an image of the cooking material 2 obtained through the camera 120 according to an embodiment of the disclosure, and FIG. 11 is an example diagram illustrating a method for determining a number of capture guide UIs 50 based on an image of the cooking material 2 obtained through the camera 120 according to an embodiment of the disclosure. FIG. 12 is an example diagram illustrating a method for identifying whether a first cooking material, of which a portion of the cooking material is obscured by another cooking material, is present based on an image of the cooking material obtained through a camera according to an embodiment of the disclosure.

Steps S1010, S1020, and S1040 to S1060 shown in FIG. 10 may correspond with steps S710, S720, and S750 to S770 shown in FIG. 7.

Referring to FIG. 10, the processor 140 according to an embodiment of the disclosure may also identify a number of the at least one cooking materials 2 based on the first image 30, and if the identified number of the at least one cooking material 2 is in plurality, display the capture guide UIs 50 corresponding respectively to the plurality of cooking materials 2 at the first area of the door 110 (S1030). At this time, the volume information of the at least one cooking material 2 may be generated for each of the plurality of cooking materials 2 based on the first image 30 and a plurality of second images 40 obtained by the user terminal device 200 based on each of the capture guide UIs 50.

Specifically, the processor 140 may identify the number of cooking materials 2 in the oven 100 based on the first image 30. Specifically, the processor 140 may detect the objects included in the first image, and identify the detected number of objects. At this time, if the number of objects is identified as in plurality, the processor 140 may identify as a plurality of cooking materials 2 being placed in the oven 100. Then, the processor 140 may display capture guide UIs 50-1 and 50-2 corresponding to each of the cooking materials 2 on the door 110 according to the number of cooking materials 2.

In an example, referring to FIG. 11, the processor 140 may display, based on it being identified that there are two cooking materials 2 in the oven 100, two capture guide UIs 50-1 and 50-2 that guide to obtain front images of each of the cooking materials 2 on the door 110. At this time, the user may obtain a plurality of front images (i.e., second image 40) of each of the cooking materials 2 through the user terminal device 200, and transmit the obtained plurality of front images (i.e., second image 40) to the server device.

The processor 140 may identify the positions of each of the cooking materials 2 in the oven 100 based on the first image 30 to display the capture guide UIs 50-1 and 50-2 for each of the cooking materials 2. Then, based on the identified positions of the cooking materials 2, the positions of the capture guide UIs 50-1 and 50-2 corresponding to each of the cooking materials 2 on the door 110 may be determined. In addition, the processor 140 may determine, based on the depth information about each of the cooking materials 2 included in the first image 30, the positions of the capture guide UIs 50-1 and 50-2 corresponding to each of the cooking materials 2 on the door 110. In this respect, because the same embodiments of the disclosure described based on FIG. 7 to FIG. 9 may be applied, detailed descriptions thereof will be omitted.

Meanwhile, the processor 140 may identify, based on identifying that the cooking materials 2 in the first image are in plurality, an area corresponding to each of the cooking materials 2 in the first image, and divide into a plurality of first images 30 by cropping each of the first images 30 based on the identified area. Then, the processor 140 may respectively transmit the plurality of first images 30 to the server device through the communication interface 130. At this time, the server device may identify, based on the first image 30 and the second image 40 corresponding to each of the cooking materials 2, respective volumes of the cooking materials 2.

In addition, the processor 140 according to an embodiment of the disclosure may identify the positions of the plurality of cooking materials 2 in the oven 100 based on the first image 30, and identify, based on the identified positions of each of the cooking materials 2 in the oven 100, whether a cooking material 2, of which a portion of the cooking material 2 is obscured by another cooking material, is present from among the plurality of cooking materials 2, and display a message 60 requesting for the positions of each of the cooking materials 2 to be adjusted at the first area of the door 110 when it is identified that the cooking material 2 is present. For convenience of description, the cooking material 2 of which a portion of the cooking material 2 is obscured by another cooking material will be referred to as a first cooking material below.

Specifically, when the user captures each of the cooking materials 2 through the user terminal device 200 as the plurality of cooking materials is disposed in the oven 100, a second image 40 of which the front image of the cooking material 2 is not wholly included may be obtained. That is, based on the state in which the plurality of cooking materials 2 is disposed, one area of the cooking material 2 disposed at a rear direction may be obscured by the cooking material 2 disposed at a relatively front direction from among the plurality of cooking materials 2.

Referring to FIG. 12, a left area of a cooking material 2-2 disposed at the rear direction may be obscured by a cooking material 2-1 disposed at a front direction from among the two cooking materials 2-1 and 2-2 in the oven 100. Accordingly, if the user obtains the second image 40 for each of the two cooking materials 2-1 and 2-2 through the user terminal device 200, the front surface of the cooking materials 2 may not be wholly included in the second image 40 for the cooking material 2-2 disposed at the rear direction. This may lead to a result of the server device not being able to accurately identify the volume for the cooking material 2-2 disposed at the rear direction. Accordingly, the processor 140 may identify the cooking material 2-2 disposed at the relatively rear direction as the first cooking material from among the plurality of cooking materials 2-1 and 2-2. Then, the message 60 requesting for the position of the plurality of cooking materials 2 in the oven 100 to be adjusted at the first area of the door 110.

Meanwhile, the processor 140 may identify, in order to identify whether the first cooking material, of which a portion of the cooking material 2 is obscured by another cooking material, is present from among the plurality of cooking materials 2-1 and 2-2, the positions of each of the cooking materials 2 based on the first image 30. Specifically, the first coordinate value and the second coordinate value of each of the cooking materials 2 may be identified, and whether the first cooking material, of which a portion of the cooking material 2 is obscured by another cooking material, is present from among the plurality of cooking materials 2-1 and 2-2 may be identified based on the identified first coordinate value and second coordinate value of each of the cooking materials 2

Then, the processor 140 may display the message 60 requesting to adjust the positions of each of the cooking materials 2 at the first area of the door 110 based on it being identified that the cooking material 2 is present.

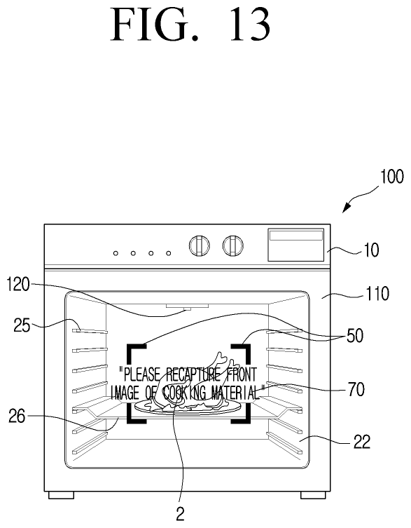

FIG. 13 is an example diagram illustrating an example of displaying a recapture request message on the oven 100 according to having received the recapture request signal of a server according to an embodiment of the disclosure.

In addition, the processor 140 according to an embodiment of the disclosure may adjust, based on receiving a recapture request signal for the second image 40 from the server device through the communication interface 130, at least one from among the size of the capture guide UI 50 or the position of the capture guide UI 50 on the first area of the door 110 based on the recapture request signal, and display a recapture message 70 of the second image 40 on the first rea of the oven 100.

Specifically, despite the processor 140 having appropriately displayed the capture guide UI 50, the second image 40 may not be correctly obtained due to inexperience of the user in operating the user terminal device 200. For example, the front image of the cooking material 2 may be inaccurately obtained due to shaking and the like of the user terminal device 200. Based on the above, because it may be difficult for the server device to measure an accurate volume of the cooking materials 2, the server device may transmit the recapture request signal to the oven 100 when the second image 40 is identified as inappropriate. Then, as in FIG. 13, if the processor 140 receives the recapture request signal through the communication interface 130, the recapture message may be displayed on the first area of the oven 100 by controlling the display panel 111. Then, the processor 140 may control the display panel 111 and display the capture guide UI 50 again at the first area of the oven 100 after displaying the recapture message 70.

Meanwhile, the server device may analyze the received second image 40, and request, to the oven 100, to adjust the capture guide UI 50 displayed at the first area of the door 110 so as to obtain a more appropriate second image 40. Specifically, the server device may transmit, to the oven 100, a signal requesting to adjust the size, the position, and the like of the capture guide UI 50. Then, the processor 140 may display the adjusted capture guide UI 50 on the second area of the door 110 by controlling the display panel 111 after having adjusted the position, the size, and the like of the capture guide UI 50 based on a adjust signal of the capture guide UI 50 (or a regeneration signal of the capture guide UI 50) received through the communication interface 130.

Meanwhile, in the description above, steps S410 to S450 and S710 to S770 and S1010 to S1060 may be further divided into additional steps, or combined with smaller steps according to an implementation of the disclosure. In addition, a portion of the steps may be omitted according to necessity, and an order between the steps may be changed.

Meanwhile, methods according to the various embodiments of the disclosure described above may be implemented in an application form installable in an oven of the related art. Alternatively, methods according to the various embodiments of the disclosure described above may be performed using a deep learning-based trained neural network (or deep trained neural network), that is, a learning network model. In addition, the methods according to the various embodiments of the disclosure described above may be implemented with only a software upgrade, or a hardware upgrade for the oven of the related art. In addition, the various embodiments of the disclosure described above may be performed through an embedded server provided in the electronic device, or an external server of the oven.

Meanwhile, according to an embodiment of the disclosure, the various embodiments described above may be implemented with software including instructions stored in a machine-readable storage media (e.g., computer). The machine may call an instruction stored in a storage medium, and as a device operable according to the called instruction, may include a display device (e.g., display device (A)) according to the above-mentioned embodiments. Based on a command being executed by the processor, the processor may directly or using other elements under the control of the processor perform a function corresponding to the command. The command may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, respective elements (e.g., a module or a program) according to the various embodiments described above may be formed of a single entity or a plurality of entities, and a portion of sub-elements of the above-mentioned sub-elements may be omitted or other sub-elements may be further included in the various embodiments. Alternatively or additionally, a portion of the elements (e.g., modules or programs) may be integrated into one entity to perform the same or similar functions performed by the respective corresponding elements prior to integration. Operations performed by a module, a program, or other element, in accordance with the various embodiments, may be executed sequentially, in parallel, repetitively, or in a heuristically manner, or at least a portion of the operations may be performed in a different order, omitted, or a different operation may be added.

While the disclosure has been illustrated and described with reference to example embodiments thereof, it will be understood that the example embodiments are intended to be illustrative, not limiting. It will be understood by those skilled in the art that various changes in form and details may be made therein without departing from the true spirit and full scope of the disclosure, including the appended claims and their equivalents.

1. An oven, comprising:
a door to be connected to one side of the oven such that while the door is connected to the one side of the oven, the door opens and closes the oven, the door including a display panel at an area of the display panel that is transparent;
a camera;
a communication interface; and
one or more processors configured to:
obtain a first image set of at least one cooking material to be cooked in the oven using the camera,
display a guide user interface (UI) for guiding capturing of the at least one cooking material at an area of the door based on the obtained first image set,
transmit the first image set to a server device through the communication interface,
receive volume information of the at least one cooking material from the server device, and
determine a cooking process for the at least one cooking material based on the volume information,
wherein the volume information of the at least one cooking material is obtained based on the first image set and a second image set obtained by a user terminal device according to the guide UI.

2. The oven of claim 1, wherein the one or more processors are configured to:
identify, based on the first image set, a position of the at least one cooking material,
identify a position of the guide UI on the area of the door based on the identified position of the at least one cooking material, and
display the guide UI at the identified position.

3. The oven of claim 1, wherein
the one or more processors are configured to:
identify, based on the first image set, a number of the at least one cooking material, and display, based on a plurality of cooking materials being identified, guide UIs corresponding to each of the plurality of cooking materials at the area of the door, and
wherein the volume information of each of the plurality of cooking materials is obtained based on the first image set and the second image set obtained by a user terminal device according to each of the guide UIs.

4. The oven of claim 3, wherein
the one or more processors are configured to:
identify positions of the plurality of cooking materials in the oven based on the first image set,
identify, based on the identified positions of the plurality of cooking materials in the oven, whether a first cooking material of which a portion is obscured by another cooking material is present, and display a message requesting for the positions of the plurality of cooking materials to be adjusted at the area of the door based on the first cooking material being identified as being present.

5. The oven of claim 1, wherein
the one or more processors are configured to:
identify, based on the first image set, a first length of the at least one cooking material, determine a second length of the guide UI based on the identified first length, and display the guide UI having the determined second length at the area of the door.

6. The oven of claim 1, wherein
the one or more processors are configured to:
identify a type of the at least one cooking material based on the first image set, determine, based on the identified type of the at least one cooking material and volume information of the at least one cooking material, a cooking process corresponding to the at least one cooking material, and perform cooking of the at least one cooking material based on the identified cooking process.

7. The oven of claim 1, wherein
the one or more processors are configured to:
adjust, based on receiving a recapture request signal for the second image set from the server device through the communication interface, at least one from among a size of the guide UI or a position of the guide UI on the area of the door based on the recapture request signal, and display a recapture message of the second image set on the area of the oven.

8. The oven of claim 1, wherein
the first image set comprises an upper image of the at least one cooking material obtained through the camera, and the second image set comprises a front image of the at least one cooking material obtained through the user terminal device.

9. A method for controlling an oven, the method comprising:
obtaining a first image set of at least one cooking material that is to be cooked in the oven using a camera;
displaying a guide user interface (UI) for guiding capturing of the at least one cooking material at an area of a door of the oven that is transparent based on the obtained first image set;
transmitting the first image set to a server device through a communication interface of the oven;
receiving volume information of the at least one cooking material from the server device; and
determining a cooking process for the at least one cooking material based on the volume information,
wherein the door is connected to one side of the oven to open and close the oven and includes a display panel at the area, and
wherein the volume information of the at least one cooking material is obtained based on the first image set and a second image set obtained by a user terminal device according to the guide UI.

10. The method of claim 9, wherein
the displaying comprises
identifying, based on the first image set, a position of the at least one cooking material;
identifying a position of the guide UI on the area of the door based on the identified position of the cooking material; and
displaying the guide UI at the identified position.

11. The method of claim 9, wherein
the displaying comprises
identifying, based on the first image set, a number of the at least one cooking material; and
displaying, based on a plurality of cooking materials being identified, guide UIs corresponding to each of a plurality of cooking materials at the area of the door, and
wherein the volume information of each of the plurality of cooking materials is obtained based on the first image set and the second image set obtained by a user terminal device according to each of the guide UIs.

12. The method of claim 11, comprising:
identifying positions of the plurality of cooking materials in the oven based on the first image set;
identifying, based on the identified positions of the plurality of cooking materials in the oven, whether a first cooking material of which a portion is obscured by another cooking material is present; and
displaying a message requesting for the positions of the plurality of cooking materials to be adjusted at the area of the door based on the first cooking material being identified as being present.

13. The method of claim 9, wherein
the displaying comprises
identifying, based on the first image set, a first length of the at least one cooking material, determining a second length of the guide UI based on the identified first length, and displaying the guide UI having the determined second length at the area of the door.

14. The method of claim 9, further comprising:
identifying a type of the at least one cooking material based on the first image set, determining, based on the identified type of the cooking material and volume information of the cooking material, a cooking process corresponding to the at least one cooking material, and performing cooking of the cooking material based on the identified cooking process.

15. The method of claim 9, further comprising:
receiving a recapture request signal for the second image set from the server device through the communication interface;
adjusting at least one from among a size of the guide UI or a position of the guide UI on the area of the door based on the recapture request signal; and
displaying a recapture message of the second image set on the area of the oven.

16. The method of claim 9, wherein
the first image set comprises an upper image of the at least one cooking material obtained through the camera, and the second image set comprises a front image of the at least one cooking material obtained through the user terminal device.

17. A non-transitory computer readable recording medium storing computer instructions that cause an oven to perform an operation when executed by one or more processors of the oven, wherein the operation comprises;
obtaining a first image set of at least one cooking material that is to be cooked in the oven using a camera;
displaying a guide user interface (UI) for guiding capturing of the at least one cooking material at an area of a door of the oven that is transparent based on the obtained first image set;
transmitting the first image set to a server device through a communication interface of the oven;
receiving volume information of the at least one cooking material from the server device; and
determining a cooking process for the at least one cooking material based on the volume information,
wherein the door is connected to one side of the oven to open and close the oven and includes a display panel at the area, and
wherein the volume information of the at least one cooking material is obtained based on the first image set and a second image set obtained by a user terminal device according to the guide UI.

18. The non-transitory computer readable medium according to claim 17, wherein
the displaying comprises
identifying, based on the first image set, a position of the at least one cooking material, identifying a position of the guide UI on the area of the door based on the identified position of the cooking material, and displaying the guide UI at the identified position.

19. The non-transitory computer readable medium according to claim 17, wherein
the displaying comprises
identifying, based on the first image set, a number of the at least one cooking material; and
displaying, based on a plurality of cooking materials being identified, guide UIs corresponding to each of a plurality of cooking materials at the area of the door, and
wherein the volume information of each of the plurality of cooking materials is obtained based on the first image set and the second image set obtained by a user terminal device according to each of the guide UIs.

20. The non-transitory computer readable medium according to claim 19, further comprising:
identifying positions of the plurality of cooking materials in the oven based on the first image set;
identifying, based on the identified positions of the plurality of cooking materials in the oven, whether a first cooking material of which a portion is obscured by another cooking material is present; and
displaying a message requesting for the positions of the plurality of cooking materials to be adjusted at the area of the door based on the first cooking material being identified as being present.
